(19) United States
(12) Patent Application Publication
(10) Pub. No.: US 2023/0019468 A1
(43) Pub. Date: Jan. 19, 2023

(54) DRINKWARE COFFEE FILTER

(71) Applicant: Brian Williamson, Raleigh, NC (US)

(72) Inventor: Brian Williamson, Raleigh, NC (US)

(21) Appl. No.: 17/518,063

(22) Filed: Nov. 3, 2021

Related U.S. Application Data
(63) Continuation-in-part of application No. 17/375,684, filed on Jul. 14, 2021.

(51) Int. Cl. A47J 31/20; A23F 5/26; A47J 31/06; A47G 19/16

(52) U.S. Cl. CPC A47J 31/20; A23F 5/262; A47J 31/0626; A47G 19/16

(57) ABSTRACT

A drinkware system includes a drinkware container having at least one wall and a bottom surface; a barrier portion coupled to the at least one wall, having a first end and a second end, and defining an opening proximate to the first end, wherein the barrier portion forms a wall between a first section and a second section within the drinkware container that prevents movement of a liquid between the first section and the second section except through the opening; and a removable member coupleable to the barrier portion and including a filter, wherein the filter substantially aligns with the opening of the barrier portion when the removable member is coupled to the barrier portion.

### CROSS REFERENCE TO RELATED APPLICATIONS

This application is a continuation-in-part of U.S. patent application Ser. No. 17/375,684, filed on Jul. 14, 2021, entitled “DRINKWARE COFFEE FILTER,” the entirety of which is hereby incorporated by reference.

### FIELD

The present disclosure relates generally to coffee filters. More specifically, but not by way of limitation, this disclosure relates to devices, systems, and methods for filtering coffee in a drinkware container.

### BACKGROUND

Drinking coffee is said to have a number of health benefits for an individual. However, coffee also contains several compounds called diterpenes, e.g., cafestol oil and kahweol oil, that when ingested can have negative impacts on an individual's health. For example, ingesting these harmful cafestol oils and/or kahweol oils when drinking coffee can cause an increase in low-density lipoprotein (“LDL”) cholesterol in an individual, which can cause heart disease, heart attacks, strokes, etc.

### SUMMARY

Various examples are described for devices, systems, and methods for filtering coffee in a drinkware container. One example system includes a drinkware container having at least one wall and a bottom surface; a barrier portion coupled to the at least one wall and having a first end and a second end, and defining an opening proximate to the first end, where the barrier portion forms a wall between a first section and a second section within the drinkware container that prevents movement of a liquid between the first section and the second section except through the opening; and a removable member coupleable to the barrier portion and including a filter, where the filter substantially aligns with the opening of the barrier portion when the removable member is coupled to the barrier portion.

One example device includes a barrier portion having a first end and a second end and defining an opening proximate to the first end; and a removable member coupleable to the barrier portion and including a filter, where the filter substantially aligns with the opening of the barrier portion when the removable member is coupled to the barrier portion.

One example system includes a drinkware container having at least one wall and a bottom surface; and a barrier portion coupled to the at least one wall, having a first end, a second end and at least one curved surface, and defining an opening proximate to the first end, where the barrier portion forms a wall between a first section and a second section within the drinkware container that prevents movement of a liquid between the first section and the second section except through the opening.

These illustrative examples are mentioned not to limit or define the scope of this disclosure, but rather to provide examples to aid understanding thereof. Illustrative examples are discussed in the Detailed Description, which provides further description. Advantages offered by various examples may be further understood by examining this specification.

### BRIEF DESCRIPTION OF THE DRAWINGS

The accompanying drawings, which are incorporated into and constitute a part of this specification, illustrate one or more certain examples and, together with the description of the example, serve to explain the principles and implementations of the certain examples.

FIGS. 1A-1B show example drinkware containers for filtering coffee according to this disclosure;

FIGS. 2A-2C show example barrier portions that may be incorporated into a drinkware container for filtering coffee according to this disclosure;

FIG. 3A-3B show an example drinkware container filtering coffee according to this disclosure;

FIG. 4 shows an example drinkware container for filtering coffee according to this disclosure;

FIG. 5A shows an example drinkware container with a barrier portion for filtering coffee according to this disclosure;

FIGS. 5B-5C show a top and perspective view of the barrier portion of FIG. 5A;

FIGS. 6A-6B show example barrier portions that may be incorporated into a drinkware container for filtering coffee according to this disclosure; and

FIG. 7 shows a flowchart for an example method for brewing coffee or tea according to this disclosure.

### DETAILED DESCRIPTION

Examples are described herein in the context of devices, systems, and methods for brewing and filtering coffee and tea in a drinkware container. Those of ordinary skill in the art will realize that the following description is illustrative only and is not intended to be in any way limiting. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another.

When drinking coffee, filtering the coffee before ingesting it can help to reduce the amount of harmful oils, e.g., cafestol oil, kahweol oil, etc., ingested by the individual. Filtering while brewing the coffee often still leaves some of the harmful oils in the coffee. Additionally, several popular methods for brewing coffee, e.g., French press, Greek style, Turkish style, etc., do not filter the coffee during the preparation of the coffee at all. As such, there needs to be a device, system, and/or method for filtering the coffee after the coffee is brewed but before an individual drinks the coffee to further reduce the amount of harmful oils remaining in the coffee that may be ingested by the individual.

In an illustrative example, a drinkware container, e.g., a mug, cup, glass, etc., includes a barrier portion that separates the interior of the drinkware container into two sections, e.g., an intake section and a drinking section. At a lower end of the barrier portion is an opening that forms an opening between the intake section and the drinking section. The barrier portion has a partial frustoconical shape, such that the narrower portion is at the lower end of the barrier portion and the wider portion is at the upper end of the barrier portion, and is curved so as to form a convex wall of the intake section and a concave wall of the drinking section.

This illustrative barrier portion includes a removable member, e.g., a filter stick, that is attachable to the barrier portion. The removable member has an opening at a lower end of the removable member that is entirely covered with a filter. When the removable member is attached to the barrier portion, the removable member opening and filter substantially align with the opening of the barrier portion.

When using the illustrative drinkware container, coffee is introduced into the drinkware container in the intake section. As the coffee is poured into the intake section, it travels through the openings in the barrier portion and removable member and thus through the filter into the drinking section. The filter filters the coffee as it moves from the intake section to the drinking section to reduce the amount of harmful oils or other material (e.g., grounds, sediment, etc.) present in the coffee contained in the drinking section. The location of the opening at the lower end of the barrier portion further assists reducing the amount of harmful oils present in the coffee contained in the drinking section because the harmful oils tend to rise to the top of the coffee in the intake section when the coffee, and thus the harmful oils, is hot.

As the individual drinks the filtered coffee from the drinking section, coffee continues to travel from the intake section to the drinking section through the filter, substantially equalizing the level of the coffee contained in the two sections. When the coffee travels down the convex wall of the intake section formed by the barrier portion, the harmful oils also may adhere to the convex wall, and its curved shape may provide more surface area exposed to the coffee in the intake section than a flat wall. Thus the amount of harmful oils within the coffee contained in the drinking section is further reduced.

By using this drinkware container, an individual may drink coffee that has a reduced amount of cafestol and/or kahweol oil due to the barrier portion located between the intake section and the drinking section. Therefore, an individual may drink coffee prepared using an unfiltered brewing method while still reducing the amount of harmful oils ingested. And by reducing the amount of harmful oils ingested, the individual reduces their risk of heart disease, heart attacks, strokes, etc. caused by an increase in LDL cholesterol due to the ingestion of coffee containing those harmful oils.

This illustrative example is given to introduce the reader to the general subject matter discussed herein and the disclosure is not limited to this example. The following sections describe various additional non-limiting examples and examples of devices, systems, and methods for brewing and filtering coffee and tea in a drinkware container.

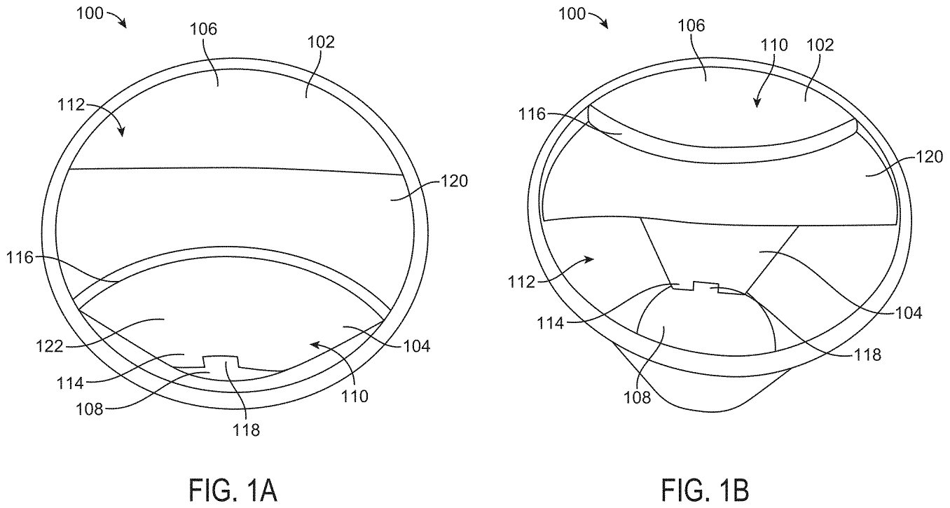

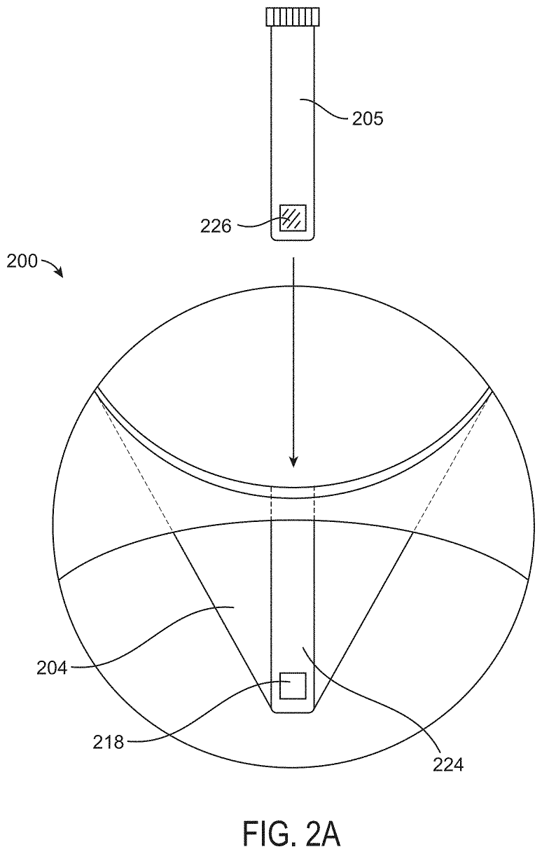

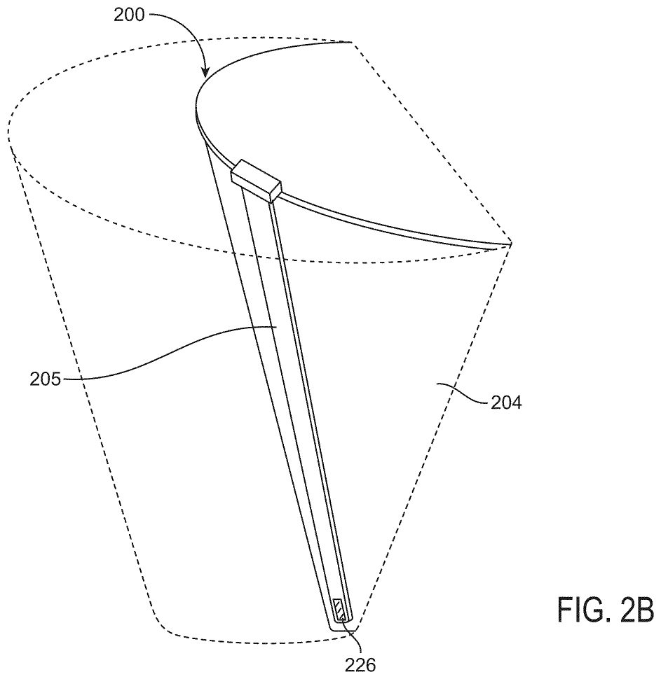

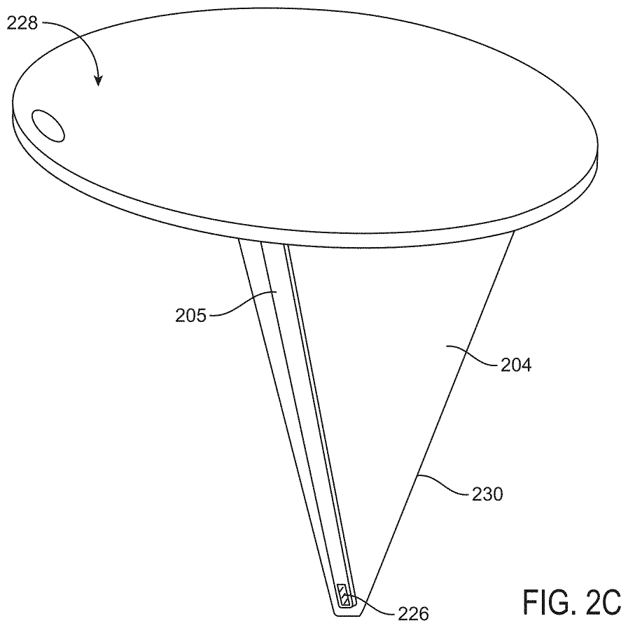

Referring now to FIGS. 1A-1B, FIGS. 1A-1B show an example drinkware system 100 for filtering coffee. In some examples, the drinkware system 100 includes a drinkware container 102 and a barrier portion 104. Additionally, the drinkware system 100 may include a removable member that is coupleable to the barrier portion 104. The removable member will be discussed in more detail below in relation to FIGS. 2A-2C.

The drinkware container 102 and the barrier portion 104 may be made out of any suitable material or materials, e.g., glass, ceramic, acrylic, plastic, metal, wood, paper, coated paper, styrofoam, porcelain, polymers, stainless steel, Steralloy 2781-5, etc., and may each be made out of the same or different material(s). In some examples, the drinkware container 102 may be a mug, a traveler mug, a cup, a glass, etc., and the drinkware container 102 and/or the barrier portion 104 may be reusable or single use.

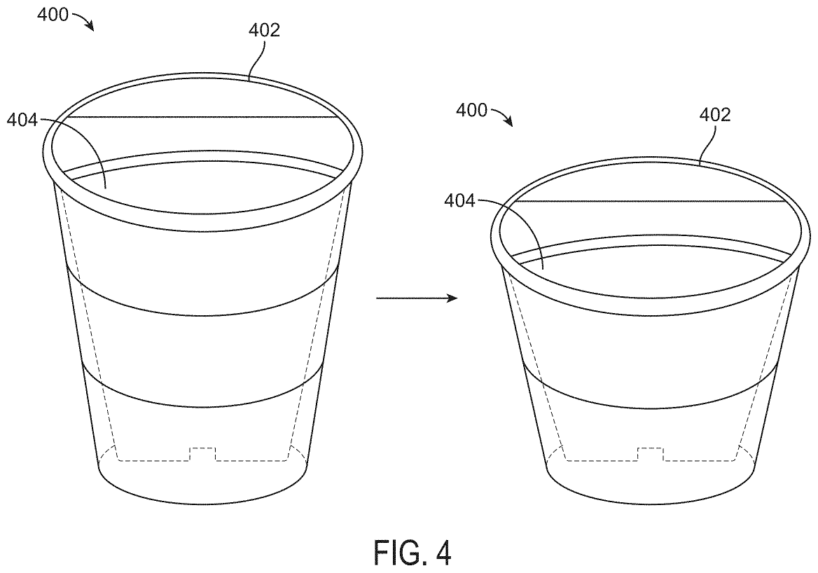

Additionally, a height of at least one of the drinkware container 102 or the barrier portion 104 may be adjustable, as may be seen in FIG. 4. For example, FIG. 4 shows an example drinkware system 400. The drinkware system 400 may be the same or similar to, or have the same or similar elements to, the drinkware system 100 described above in relation to FIGS. 1A-1B. For example, the drinkware system 400 includes a drinkware container 402 and a barrier portion 404. The drinkware container 402 and the barrier portion 404 may be the same or similar to, or have the same or similar elements to, the drinkware container 102 and the barrier portion 104, 204 described above in relation to FIGS. 1A-2C. The drinkware container 402 and/or the barrier portion 404 may have telescoping or collapsible features that allow for adjusting their respective height. In some examples, the drinkware container 402 and/or the barrier portion 404 may be formed of multiple separate pieces that are removably coupled to one another so that adding or removing various separate pieces may allow for adjusting their respective height.

In certain examples, the drinkware container 102 includes at least one wall 106 and a bottom surface 108. The barrier portion 104 is coupled to the at least one wall 106 in at least one location and may also be coupled to the bottom surface 108 in at least one location. The barrier portion 104 may be removably coupleable to the at least one wall 106, e.g., via a snap-fit connection, a friction-fit connection, etc., may be sealed to at least one of the at least one wall 106 or the bottom surface 108, e.g., due to a rubberized edge of the barrier portion 104, to a snug fit between the barrier portion 104 and at least one of the at least one wall 106 or the bottom surface 108, to a part of the barrier portion 104 sliding into at least one slot formed in at least one of the at least one wall 106 or the bottom surface 108, etc., or may be integrally formed with at least one of the at least one wall 106 or the bottom surface 108.

When arranged within the drinkware container 102, the barrier portion 104 forms a wall between a first section 110 and a second section 112 within the drinkware container 102. The size of the first section 110 and the second section 112 may depend on the placement of the barrier portion 104 within the drinkware container 102.

In some examples, the barrier portion 104 has a first end 114, which is located proximate to the bottom surface 108, and a second end 116 opposite the first end 114. The barrier portion 104 defines an opening 118 through the barrier portion 104 and proximate to the first end 114. When the barrier portion 104 is arranged within the drinkware container 102 so that a portion of the first end 114 is in contact with the bottom surface 108, the opening 118 forms an opening between the first section 110 and the second section 112.

Additionally, a lip 120 may be coupled to and/or extend from the barrier portion 104. For example, the lip 120 may be coupled to the barrier portion 104 and extend over at least a portion of at least one of the first section 110 or the second section 112. In some examples, the lip 120 may reduce splashing as the coffee is poured into the drinkware container 102. In further examples, the lip 120 may prevent the coffee from pouring over the barrier portion 104 as the user drinks from the drinkware container 102.

In certain examples, the barrier portion 104 may be shaped to have at least one curved surface 122. The at least one curved surface 122 may be arranged to form a convex wall of the first section 110 and a concave wall of the second section 112, or vice versa. The arrangement of the opening 118 proximate to the first end 114, and in some embodiments at the lowest point of the barrier portion 104, along with the shape of the at least one curved surface 122 reduces the amount of the harmful oils present in coffee from travelling from the first section 110 to the second section 112. So an individual may drink the coffee from the second section 112 while ingesting a reduced amount of the oils.

Referring now to FIGS. 2A-2C, FIGS. 2A-2C show an example drinkware insert 200 that may be used with a drinkware container. The drinkware insert 200 includes similar elements, such as a barrier portion 104, as described above in relation to FIGS. 1A-1B. Additionally, the drinkware container that the drinkware insert 200 may be used with may be the same or similar too, and may include the same or similar elements, as the drinkware container 102 described above in relation to FIGS. 1A-1B.

Here, the drinkware insert 200 includes a barrier portion 204 and a removable member 205. The removable member 205 is removably coupleable to the barrier portion 204. However, in some examples, the removable member 205 may be permanently attached to or integrally formed with the barrier portion 204. In some embodiments, the removable member 205 may be coupled with the barrier portion 204 using a snap-fit connection, a friction-fit connection, or any other suitable form of coupling. The barrier portion 204 may also include a slot 224 sized to receive the removable member 205. The slot 224 may assist in sealing, stabilizing, and/or ensuring proper alignment of the removable member 205 relative to the barrier portion 204 and may also assist in coupling the removable member 205 to the barrier portion 204, e.g. by snap-fitting or friction-fitting the removable member 205 within the slot 224.

As described above relative to the barrier portion 104 of FIGS. 1A-1B, the barrier portion 204 defines an opening 218 through the barrier portion 204 proximate to a first end of the barrier portion 204. The removable member 205 also defines an opening through the removable member 205. In some examples, a filter 226 is arranged to cover an entirety of the opening in the removable member 205. In further examples, the filter 226 may be removably coupled to the removable member 205, permanently coupled to the removable member 205, or may be integrally formed with the removable member 205.

When the removable member is coupled to the barrier portion 204, the opening through the removable member 205 substantially aligns with the opening 218 through the barrier portion 204. Thus the filter 226 substantially aligns with the opening 218 through the barrier portion 204. In some examples, the filter 226 and the removable member 205 are sized so that the entirety of the opening 218 through the barrier portion 204 is covered by the filter 226 or the filter 226 and a portion of the removable member 205.

As described above with respect to FIGS. 1A-1B, the barrier portion 204 may be coupleable to a drinkware container so that the barrier portion 204 forms a wall between a first section and a second section within the drinkware container. In some examples, the barrier portion 204 is coupleable to a lid 228, as shown in FIG. 2C, and includes a sealant 230 along at least one edge of the barrier portion 204, e.g., formed of rubber, silicone, or any other suitable material. When the lid 228 is coupled to the drinkware container, the barrier portion 204 is arranged within the drinkware container so that the barrier portion 204 forms a wall between the first section and the second section within the drinkware container. The sealant 230 may form a water-tight seal between the barrier portion 204 and the drinkware container when the lid 228 is coupled to the drinkware container.

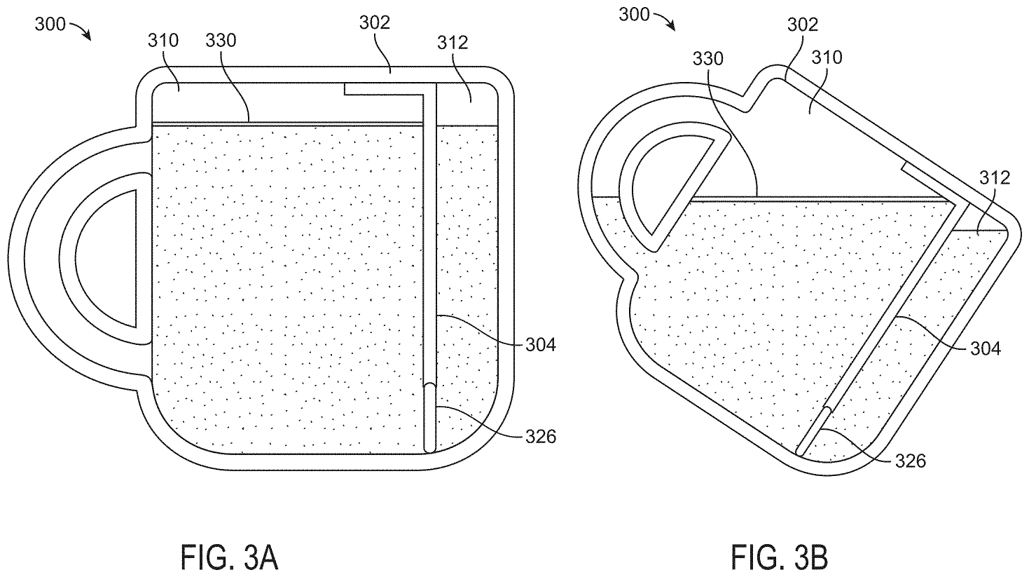

Referring now to FIGS. 3A and 3B, FIGS. 3A and 3B show an example drinkware system 300. The drinkware system 300 may be the same or similar to, or have the same or similar elements to, the drinkware system 100 described above in relation to FIGS. 1A-1B. For example, the drinkware system 300 includes a drinkware container 302 and a barrier portion 304. The drinkware container 302 and the barrier portion 304 may be the same or similar to, or have the same or similar elements to, the drinkware container 102 and the barrier portion 104, 204 described above in relation to FIGS. 1A-2C.

In some examples, the barrier portion 304 defines an opening through the barrier portion 304 and located at a first end of the barrier portion 304 and a filter 326 entirely covers the opening through the barrier portion 304. The filter 326 may be removably coupled to the barrier portion 304, permanently coupled to the barrier portion 304, or integrally formed with the barrier portion 304.

Coffee may be introduced into a first section 310 of the drinkware container 302. As the first section 310 fills with coffee, the coffee flows into a second section 312 through the opening in the barrier portion 304 and thus through the filter 326. As the coffee flows from the first section 310 to the second section 312, the filter 326 reduces the amount of oil 330 present in the coffee that travels into the second section 312. In some examples, the barrier portion 304 is curved so as to form a convex wall of the first section 310. As the coffee level drops in the first section 310 due to an individual drinking the filtered coffee from the second section 312, the oil 330 adheres to the convex curved surface of the barrier portion 304 in the first section 310, which further reduces the amount of oil 330 that travels from the first section 310 to the second section 312.

As discussed above, reducing the amount of oil 330 in the second section 312 reduces the amount of oil 330 that an individual ingests when drinking the coffee. Reducing the amount of oil 330 ingested by an individual when drinking coffee may reduce the individual's risk of heart disease, heart attack, stroke, etc. that may be caused by drinking unfiltered coffee.

The foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

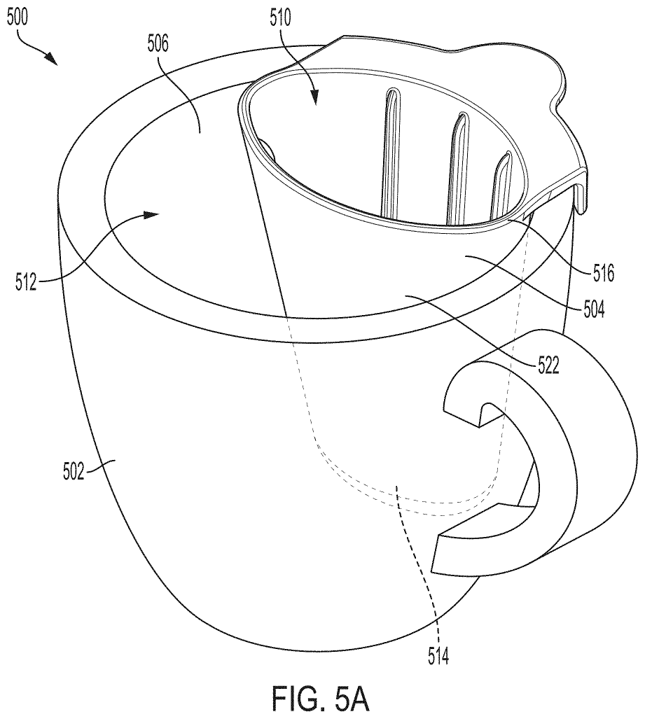

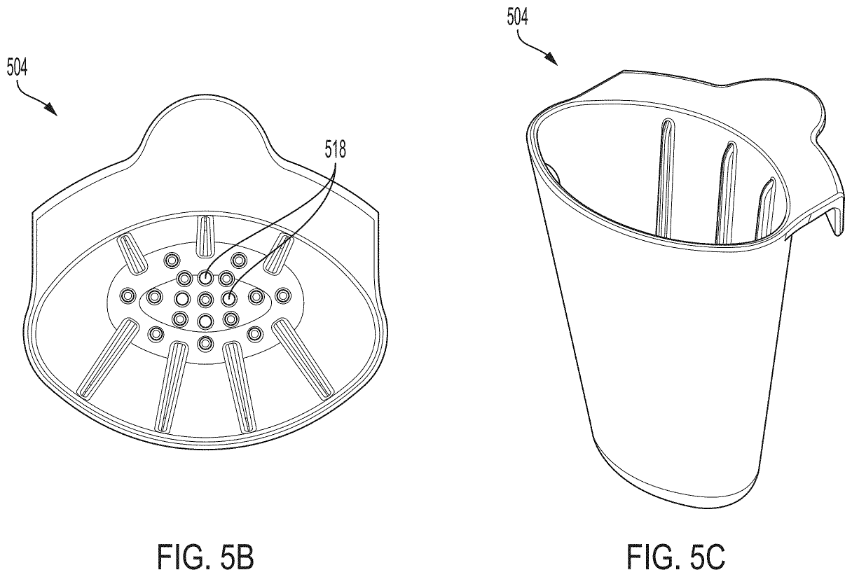

Referring now to FIGS. 5A-5C, FIG. 5A shows an example drinkware system 500 and FIGS. 5B and 5C show an example barrier portion 504. The drinkware system 500 may be the same or similar to, or have the same or similar elements to, the drinkware system 100 described above in relation to FIGS. 1A-1B. For example, the drinkware system 500 includes a drinkware container 502 and a barrier portion 504. The drinkware container 502 and the barrier portion 504 may be the same or similar to, or have the same or similar elements to, the drinkware container 102 and the barrier portion 104, 204 described above in relation to FIGS. 1A-2C. For example, the drinkware container may include at least one wall 506; the barrier portion 504 may include a first end 514, a second end 516, at least one opening 518, and a curved surface 522; and when arranged within the drinkware container 502, the barrier portion 504 may form a wall between a first section 510 and a second section 512 within the drinkware container 502. Additionally, the shape of the barrier portion 504 may result in easier cleaning of the barrier portion 504.

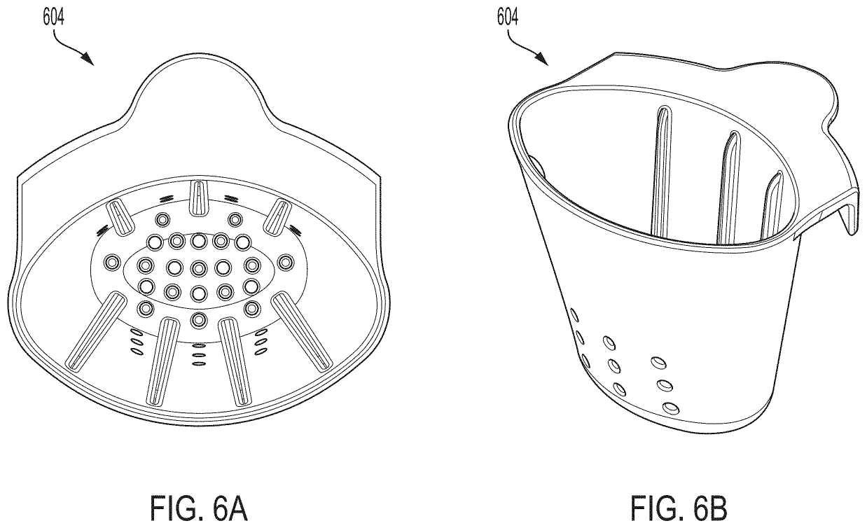

Referring now to FIGS. 6A and 6B, FIGS. 6A and 6B show an example barrier portion 604 that may be used with a drinkware container. The barrier portion 604 may be the same or similar to, or have the same or similar elements to, the barrier portion 104 described above in relation to FIGS. 1A-1B. Additionally, the drinkware container that the barrier portion 604 may be used with may be the same or similar too, and may include the same or similar elements, as the drinkware container 102 described above in relation to FIGS. 1A-1B.

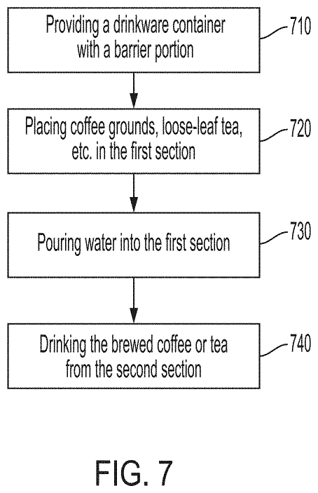

Referring now to FIG. 7, FIG. 7 shows an example method 700 for brewing coffee or tea within a drinkware container according to this disclosure. The example method 800 will be discussed with respect to the drinkware container 102 shown in FIGS. 1A-1B. However, it should be appreciated that any suitable system for brewing coffee or tea may be employed, such as that shown in FIGS. 2-6B.

At block 710, a drinkware container 102 with a barrier portion 104 is provided. Here, the barrier portion 104 forms a wall between the first section 110 and the second section 112 within the drinkware container 102 and defines at least one opening 118 through the barrier portion 104 proximate to the first end 114 of the barrier portion.

At block 720, coffee grounds, loose-leaf tea, etc. are placed in the first section 110. The amount of coffee grounds, loose-leaf tea, etc. placed in the first section 110 may determine the strength of the brewed coffee or tea. Optionally, a removable member, e.g., removable member 205 discussed above with respect to FIGS. 2A-2C, having a filter, e.g., filter 226 discussed above with respect to FIGS. 2A-2C, may be coupled to the barrier portion 104 before or after the coffee grounds, loose-leaf tea, etc. are placed in the first section 110.

At block 730, boiling water, or water having a temperature of approximately 195° F. to approximately 215° F., is poured into the first section 110 over the coffee grounds, loose-leaf tea, etc. present in the first section 110. As the water passes over the coffee grounds, loose-leaf tea, etc., the brewing of the coffee or tea begins. The water and/or brewed or partially brewed coffee or tea travels from the first section 110 to the second section 112 through the at least one opening 118. The coffee or tea may continue brewing and/or steeping while the barrier portion 104 with the coffee grounds, loose-leaf tea, etc. remains in the drinkware container 102, which may result in stronger coffee or tea.

At block 740, the brewed coffee or tea is drunk from the second section 112. In some embodiments, the barrier portion 104 and the coffee grounds, loose-leaf tea, etc. may be removed from the drinkware container 102 prior to drinking from the second section 112; however, this is not required.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one embodiment,” “in an embodiment,” “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

That which is claimed is:

1. A drinkware system comprising:
a drinkware container comprising at least one wall and a bottom surface;
a barrier portion removably coupled to the at least one wall and comprising a first end and a second end, and defining at least one opening proximate to the first end, wherein the barrier portion forms at least one wall between a first section and a second section within the drinkware container that prevents movement of a liquid between the first section and the second section except through the at least one opening; and
a removable member coupleable to the barrier portion and comprising a filter, wherein the filter substantially aligns with the at least one opening of the barrier portion when the removable member is coupled to the barrier portion.

2. The drinkware system of claim 1, wherein the barrier portion is removably coupled to the at least one wall of the drinkware container via at least one of a snap fit connection or a friction fit connection.

3. The drinkware system of claim 1, wherein the barrier portion comprises a curved surface.

4. The drinkware system of claim 3, wherein the curved surface forms a convex wall of the first section.

5. The drinkware system of claim 1, wherein the at least one wall formed by the barrier portion completely surrounds the first section.

6. The drinkware system of claim 1, wherein the first end of the barrier portion is spaced apart from the bottom surface.

7. The drinkware system of claim 1, wherein the removable member is coupleable to the barrier portion via a snap fit or a friction fit.

8. A drinkware insert comprising:
a barrier portion having a cupped shape, comprising a first end and a second end and defining a plurality of openings proximate to the first end; and
a removable member coupleable to the barrier portion and comprising a filter, wherein the filter substantially aligns with the plurality of openings of the barrier portion when the removable member is coupled to the barrier portion.

9. The drinkware insert of claim 8, wherein the barrier portion is removably coupleable to a drinkware container to form a wall between a first section and a second section and completely surrounding the first section within the drinkware container that prevents movement of a liquid between the first section and the second section except through the plurality of openings.

10. The drinkware insert of claim 8, wherein the plurality of openings are arranged at a lowest point of the barrier portion.

11. The drinkware insert of claim 8, wherein a height of the barrier portion is adjustable.

12. The drinkware insert of claim 8, wherein the barrier portion is removably coupleable with at least one wall of a drinkware container.

13. The drinkware insert of claim 8, wherein the barrier portion comprises a slot sized to receive the removable member.

14. The drinkware insert of claim 8, wherein the removable member is coupleable to the barrier portion via a snap fit or a friction fit.

15. A method for brewing a coffee beverage or a tea beverage in a drinkware container, the method comprising:
providing the drinkware container comprising at least one wall and a barrier portion removably coupled to the at least one wall and defining at least one opening, wherein the barrier portion forms a wall between a first section and a second section within the drinkware container that prevents movement of a liquid between the first section and the second section except through the at least one opening;
placing coffee grounds or loose-leaf tea in the first section; and
pouring water having a temperature of approximately 195° F. to approximately 215° F. into the first section causing the coffee grounds or loose-leaf tea to brew in the drinkware container.

16. The method of claim 15, further comprising drinking the brewed coffee beverage or the brewed tea beverage from the second section.

17. The method of claim 15, further comprising coupling a removable member comprising a filter to the barrier portion.

18. The method of claim 17, wherein the filter substantially aligns with the at least one opening.

19. The method of claim 15, further comprising removing the barrier portion from the drinkware container prior to drinking the brewed coffee beverage or the brewed tea beverage from the second section.

20. The method of claim 19, wherein a strength of the brewed coffee beverage or the brewed tea beverage is determined based on an amount of time that the barrier portion remains in the drinkware container.
